(19) United States
(12) Patent Application Publication
(10) Pub. No.: US 2022/0160573 A1
(43) Pub. Date: May 26, 2022

(54) WALKING ASSISTANCE SYSTEM

(71) Applicant: TOYOTA JIDOSHA KABUSHIKI KAISHA, Aichi-ken (JP)

(72) Inventors: Mashio TANIGUCHI, Toyota-shi (JP); Hiroaki KAWAMURA, Toyota-shi (JP); Yukiko OHNISHI, Toyota-shi (JP); Masatoshi KAKUTANI, Toyota-shi (JP); Mariko HIGUCHI, Toyota-shi (JP)

(21) Appl. No.: 17/507,749

(22) Filed: Oct. 21, 2021

(30) Foreign Application Priority Data
Nov. 25, 2020 (JP) 2020-195061

(51) Int. Cl. A61H 3/06

(52) U.S. Cl. CPC A61H 3/061; A61H 3/068

(57) ABSTRACT

An alert level of an operation for issuing an alert to a driver of a bicycle is set high in a case where a determination is made that the driver of the bicycle that approaches a pedestrian is unaware of a presence of the pedestrian, as compared with a case where a determination is made that the driver is aware of the presence of the pedestrian. For example, the alert level is increased by increasing an amount of light of a laser beam in a case where a circle having a predetermined radius is drawn by the laser beam on a road surface from a white cane owned by the pedestrian who is a person who is visually impaired.

### CROSS-REFERENCE TO RELATED APPLICATION

This application claims priority to Japanese Patent Application No. 2020-195061 filed on Nov. 25, 2020, incorporated herein by reference in its entirety.

### BACKGROUND

### 1. Technical Field

The present disclosure relates to a walking assistance system. In particular, the present disclosure relates to measures for improving reliability of avoiding contact of a moving body, such as a bicycle, with a pedestrian.

### 2. Description of Related Art

A system disclosed in Japanese Unexamined Patent Application Publication No. 2011-106978 (JP 2011-106978 A) is known as a system for avoiding contact of a moving body, such as a bicycle, with a pedestrian. JP 2011-106978 A discloses that a distance d between the pedestrian and the moving body (bicycle) that approaches the pedestrian is periodically detected by an infrared transmitter and an infrared receiver provided in a safety response device owned by the pedestrian, when the distance d is a value smaller than a predetermined allowable distance D, a warning mechanism is activated and emits sound or blinking light to issue an alert to the pedestrian, and the pedestrian is allowed to be prepared for an emergency.

### SUMMARY

However, the system disclosed in JP 2011-106978 A basically issues the alert to the pedestrian. Therefore, even in a case where the alert is issued to the pedestrian, for example, when the moving body approaches from behind the pedestrian, there is a possibility that the moving body comes into contact with the pedestrian when an occupant (driver) of the moving body does not drive to avoid the pedestrian. That is, with the technique disclosed in JP 2011-106978 A, the pedestrian can be allowed to be prepared for the emergency by issuing the alert to the pedestrian (described in paragraph [0007] in JP 2011-106978 A), but contact of the moving body with the pedestrian cannot be avoided solely by issuing the alert.

In view of this point, the inventors of the present disclosure have focused on the fact that in order to improves the reliability of avoiding contact of the moving body with the pedestrian, issuing the alert to the occupant of the moving body to make the occupant of the moving body take contact avoidance behavior (driving the moving body without coming into contact with the pedestrian) is more effective than issuing the alert to the pedestrian. In particular, in a case where the pedestrian is a person who is visually impaired, it is difficult for the person who is visually impaired to recognize the approach of the moving body even when the moving body approaches from the front, and thus making the occupant of the moving body to take the contact avoidance behavior is effective as compared with a case where the pedestrian is a person with no disability.

Further, the inventors of the present disclosure have considered that in order to make the occupant of the moving body take the contact avoidance behavior, it is a condition that the occupant of the moving body is aware of the presence of the pedestrian (aware that the moving body approaches the pedestrian). Also, the inventors of the present disclosure have obtained new knowledge that in a case where the occupant of the moving body is already aware of the presence of the pedestrian, the contact avoidance behavior by the occupant can be expected, and thus a need for issuing the alert to the occupant is low, whereas in a case where the occupant of the moving body is unaware of the presence of the pedestrian, in order to make the occupant take the contact avoidance behavior, there is a need for issuing a strong alert for making the occupant be aware of the presence of the pedestrian.

The present disclosure has been made in view of this point, and is to provide a walking assistance system that issues a strong alert for making an occupant of a moving body be aware of a presence of a pedestrian in a case where the occupant is unaware of the presence of the pedestrian, and improves the reliability of avoiding contact of the moving body with the pedestrian by issuing the strong alert.

A first aspect of the present disclosure relates to a walking assistance system that performs an operation for avoiding contact of a moving body with a pedestrian in a case where the moving body approaches the pedestrian. The walking assistance system includes a determination unit configured to receive information from a moving body detection unit that has detected the moving body in a situation where the moving body approaches the pedestrian and to determine whether or not the moving body or an occupant of the moving body is aware of a presence of the pedestrian, and an alert level setting unit configured to output information in which an alert level of an operation for issuing an alert to the moving body or the occupant of the moving body is set high, the operation being performed by an alert unit, in a case where the determination unit determines that the moving body or the occupant of the moving body is unaware of the presence of the pedestrian, as compared with a case where the determination unit determines that the moving body or the occupant of the moving body is aware of the presence of the pedestrian.

Further, a second aspect of the present disclosure relates to a walking assistance system that performs an operation for avoiding contact of a moving body with a pedestrian in a case where the moving body approaches the pedestrian. The walking assistance system includes a moving body detection unit, an alert unit, a determination unit, and an alert level setting unit. The moving body detection unit is configured to detect the moving body that approaches the pedestrian. The alert unit is configured to perform an operation for issuing an alert to the moving body or an occupant of the moving body. The determination unit is configured to receive information from the moving body detection unit and determine whether or not the moving body or the occupant of the moving body is aware of a presence of the pedestrian. The alert level setting unit is configured to output information in which an alert level of the operation for issuing the alert by the alert unit is set high, in a case where the determination unit determines that the moving body or the occupant of the moving body is unaware of the presence of the pedestrian, as compared with a case where the determination unit determines that the moving body or the occupant of the moving body is aware of the presence of the pedestrian.

Examples of the occupant of the moving body in these specific matters include a driver of a bicycle, a driver of a vehicle, and a driver of a train. Further, examples of the moving body include a human and an animal.

According to each of the specific matters described above, in the situation where the moving body approaches the pedestrian, the moving body detection unit detects the moving body. Then, the determination unit determines whether or not the moving body or the occupant of the moving body is aware of the presence of the pedestrian. In the situation where the moving body approaches the pedestrian, the alert unit performs the operation for issuing the alert to the moving body or the occupant of the moving body, and the alert level setting unit sets the alert level of the operation for issuing the alert by the alert unit high, in a case where the determination unit determines that the moving body or the occupant of the moving body is unaware of the presence of the pedestrian, as compared with a case where the determination unit determines that the moving body or the occupant of the moving body is aware of the presence of the pedestrian. As described above, by setting the alert level high in a case where the determination unit determines that the moving body or the occupant of the moving body is unaware of the presence of the pedestrian, a possibility of making the moving body or the occupant of the moving body be aware of the presence of the pedestrian (aware that the moving body or the occupant of the moving body approaches the pedestrian) is increased. As a result, a possibility that the moving body or the occupant of the moving body takes the contact avoidance behavior is increased, and the reliability of avoiding contact of the moving body with the pedestrian can be improved.

Further, the moving body detection unit is a camera configured to image a periphery of the pedestrian, and the determination unit is configured to determine whether or not the moving body or the occupant of the moving body is aware of the presence of the pedestrian by recognizing a movement state of the moving body or a state of the occupant of the moving body, based on information on an image transmitted from the camera.

In this case, the camera that is the moving body detection unit images the moving body or the occupant of the moving body that approaches the pedestrian, and transmits the information on the image to the determination unit. The determination unit recognizes the situation where the moving body approaches the pedestrian, and determines whether or not the moving body or the occupant of the moving body is aware of the presence of the pedestrian based on the information in the image. For example, by acquiring a traveling direction or speed of the moving body from the information on the image, the determination unit determines whether or not the moving body is aware of the presence of the pedestrian. Further, by recognizing a direction of a face of the occupant of the moving body from the information on the image, the determination unit determines whether or not the occupant of the moving body is aware of the presence of the pedestrian. As described above, the determination unit determines whether or not the moving body or the occupant of the moving body is aware of the presence of the pedestrian based on the information on the image captured by the camera, so that high reliability of the determination can be obtained.

Further, the moving body is a bicycle, the determination unit is configured to determine whether or not a driver who is the occupant of the bicycle is aware of the presence of the pedestrian, and the alert unit is configured to perform the operation for issuing the alert to the driver of the bicycle.

In this case, the moving body detection unit detects the bicycle that approaches the pedestrian and the driver thereof, and transmits the information to the determination unit. The determination unit recognizes that the bicycle approaches the pedestrian, and determines whether or not the driver of the bicycle is aware of the presence of the pedestrian based on the information. For example, as described above, in a case where the moving body detection unit is the camera, the determination unit determines, from the captured image, that the driver of the bicycle is aware of the presence of the pedestrian when the recognition is made that the face of the driver of the bicycle faces the position of the pedestrian, and determines that the driver of the bicycle is unaware of the presence of the pedestrian when the recognition is made that the face of the driver of the bicycle does not face the position of the pedestrian. Then, in a case where the determination unit determines that the driver of the bicycle is unaware of the presence of the pedestrian, the alert level setting unit sets the alert level of the operation for issuing the alert by the alert unit high. As a result, the possibility of making the driver of the bicycle be aware of the presence of the pedestrian (aware that the driver of the bicycle approaches the pedestrian) is increased. As a result, a possibility that the driver of the bicycle takes the contact avoidance behavior is increased, and the reliability of avoiding contact of the bicycle with the pedestrian can be improved.

Further, the alert unit is configured to emit light to a road surface in a periphery of a position of the pedestrian, as the operation for issuing the alert to the moving body or the occupant of the moving body, and an operation for raising the alert level of the operation for issuing the alert is at least one of an operation for increasing an amount of the light as compared with an operation with a low alert level, an operation for blinking the light in contrast with an operation for not blinking the light as the operation with the low alert level, an operation for increasing blinking speed of the light in a case where the light is blinked as the operation for issuing the alert, as compared with the operation with the low alert level, an operation for increasing scanning speed of the light in a case where the light is scanned in the periphery of the position of the pedestrian as the operation for issuing the alert, as compared with the operation with the low alert level, and an operation for emitting light of a color with a long wavelength as compared with the operation with the low alert level.

By raising the alert level by these units in a case where the determination unit determines that the moving body or the occupant of the moving body is unaware of the presence of the pedestrian, the possibility of making the moving body or the occupant of the moving body be aware of the presence of the pedestrian can be increased.

Further, the alert unit is configured to issue a warning sound to the moving body or the occupant of the moving body as the operation for issuing the alert to the moving body or the occupant of the moving body, and an operation for raising the alert level of the operation for issuing the alert is at least one of an operation for increasing volume of the warning sound as compared with an operation with a low alert level, and an operation for increasing a frequency of the warning sound as compared with the operation with the low alert level.

Also, by raising the alert level by these units, the possibility of making the moving body or the occupant of the moving body be aware of the presence of the pedestrian can be increased.

Further, the alert unit is configured to cause a vibration of a terminal carried by the moving body or the occupant of the moving body as the operation for issuing the alert to the moving body or the occupant of the moving body, and an operation for raising the alert level of the operation for issuing the alert is at least one of an operation for increasing amplitude of the vibration as compared with an operation with a low alert level, and an operation for reducing an interval of the vibration in a case where the vibration is intermittently caused as the operation for issuing the alert, as compared with the operation with the low alert level.

Also, as described above, by raising the alert level by using the terminal carried by the moving body or the occupant of the moving body, the possibility of making the moving body or the occupant of the moving body be aware of the presence of the pedestrian can be increased.

Further, in a case where the alert unit issues the warning sound, the terminal carried by the moving body or the occupant of the moving body may issue the warning sound. In this case, the operation for raising the alert level of the operation for issuing the alert is at least one of the operation for increasing the volume of the warning sound as compared with the operation with the low alert level, and the operation for increasing the frequency of the warning sound as compared with the operation with the low alert level.

Also, in this case, by raising the alert level by using the terminal carried by the moving body or the occupant of the moving body, the possibility of making the moving body or the occupant of the moving body be aware of the presence of the pedestrian can be increased.

Further, the alert unit is configured to generate a smell from a terminal carried by the moving body or the occupant of the moving body as the operation for issuing the alert to the moving body or the occupant of the moving body, and an operation for raising the alert level of the operation for issuing the alert is an operation for increasing intensity of the smell as compared with an operation with a low alert level.

Also, in this case, by raising the alert level by using the terminal carried by the moving body or the occupant of the moving body, the possibility of making the moving body or the occupant of the moving body be aware of the presence of the pedestrian can be increased.

Further, each of the moving body detection unit, the alert unit, the determination unit, and the alert level setting unit is provided in one of a use article, a carrying article, or a wearing article of the pedestrian, a carrying article or a wearing article of the moving body, a carrying article or a wearing article of the occupant of the moving body, and a facility installed on a road.

Examples of the use article of the pedestrian (pedestrian that the moving body approaches) described herein include a white cane in a case where the pedestrian is the person who is visually impaired, and a cane or a rollator in a case where the pedestrian is an aged person. Examples of the carrying article of the pedestrian include a portable terminal (cellular phone or the like), and a bag. Examples of the wearing article of the pedestrian include eyeglasses, a belt, a hat, and shoes. In addition, examples of the carrying article of the moving body (moving body that approaches the pedestrian) include a portable terminal and a bag in a case where the moving body is a human Examples of the wearing article of the moving body include eyeglasses, a belt, a hat, and shoes in the case where the moving body is a human. In addition, examples of the carrying article of the occupant of the moving body include a portable terminal and a bag. Examples of the wearing article of the occupant of the moving body include eyeglasses, a belt, a hat, and shoes. In addition, examples of the facility installed on the road include a street light, a traffic light, and a utility pole. By constructing the walking assistance system by effectively using an existing article, device, or facility as described above, the cost for realizing the walking assistance system can be reduced.

In particular, it is difficult for the person who is visually impaired to recognize the approach of the moving body even when the moving body approaches from the front, and thus making the occupant of the moving body or the like to take the contact avoidance behavior is effective as compared with a case where the pedestrian is a person with no disability. Further, in a case where the moving body detection unit, the alert unit, the determination unit, and the alert level setting unit are built in a white cane used by the person who is visually impaired, even when the carrying article or the like of the occupant of the moving body does not support the walking assistance system, the possibility of making the occupant of the moving body be aware of the presence of the pedestrian can be increased, and the reliability of avoiding contact of the moving body with the pedestrian can be improved. That is, since the walking assistance system is realized solely with the white cane, a highly practical walking assistance system can be provided.

In the present disclosure, the alert level setting unit sets the alert level of the operation for issuing the alert to the moving body or the occupant of the moving body high in a case where the determination unit determines that the moving body or the occupant of the moving body that approaches the pedestrian is unaware of the presence of the pedestrian, as compared with a case where the determination unit determines that the moving body or the occupant of the moving body is aware of the presence of the pedestrian. As a result, in a case where the moving body or the occupant of the moving body is unaware of the presence of the pedestrian, the possibility of making the moving body or the occupant of the moving body be aware the presence of the pedestrian (aware that the moving body or the occupant of the moving body approaches the pedestrian) can be increased. As a result, a possibility that the moving body or the occupant of the moving body takes the contact avoidance behavior is increased, and the reliability of avoiding contact of the moving body with the pedestrian can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a white cane in which a walking assistance system according to an embodiment is built;

FIG. 2 is a schematic diagram showing an inside of a grip portion of the white cane and an inside of a shaft portion of the white cane;

FIG. 3 is a block diagram showing a schematic configuration of a control system of the walking assistance system;

FIG. 4 is a flowchart showing a procedure of a walking assistance operation by the walking assistance system;

FIG. 5 is a diagram for describing an operation in a case where a bicycle approaches a person who is visually impaired who has the white cane;

FIGS. 6A to 6C are diagrams showing modification examples of an emission mode of a laser beam to a road surface;

FIGS. 7A to 7E are block diagrams showing schematic configurations of modification examples in which the walking assistance system is constructed by two devices or facilities; and

FIGS. 8A and 8B are block diagrams showing schematic configurations of modification examples in which the walking assistance system is constructed by three devices or facilities.

### DETAILED DESCRIPTION OF EMBODIMENTS

Hereinafter, an embodiment of the present disclosure will be described based on the drawings. In the present embodiment, a case where a walking assistance system according to the embodiment of the present disclosure is built in a white cane used by a person who is visually impaired will be described. Further, in the present embodiment, a case where a moving body is a bicycle will be described as an example. It should be noted that a pedestrian in the present disclosure is not limited to the person who is visually impaired and the moving body is not limited to the bicycle.

Schematic Configuration of White Cane

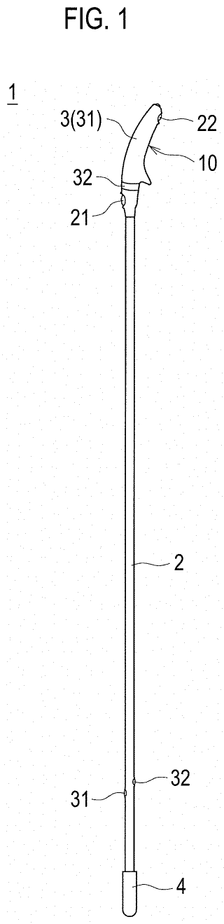

FIG. 1 is a diagram showing a white cane 1 in which a walking assistance system 10 according to the present embodiment is built. As shown in FIG. 1, the white cane 1 includes a shaft portion 2, a grip portion 3, and a tip portion (ferrule) 4.

The shaft portion 2 has a hollow rod shape having a substantially circular cross section, and is made of an aluminum alloy, a glass fiber reinforced resin, a carbon fiber reinforced resin, or the like.

The grip portion 3 is configured by mounting a cover 31 made of an elastic body, such as rubber, on a base end portion (upper end portion) of the shaft portion 2. Further, the grip portion 3 of the white cane 1 according to the present embodiment has a shape slightly curved toward a distal end side (upper side in FIG. 1) in consideration of ease of holding and slip resistance in a case of being gripped by the person who is visually impaired.

The tip portion 4 is a substantially bottomed tubular member made of a hard synthetic resin or the like, and is inserted to a distal end portion of the shaft portion 2 and fixed by means, such as adhesion or screwing. It should be noted that, for safety, the tip portion 4 has a hemispherical end surface on the distal end side.

The white cane 1 according to the present embodiment is a straight cane that cannot be folded, but may be foldable or expandable and contractible at one or a plurality of locations in an intermediate portion of the shaft portion 2.

Configuration of Walking Assistance System

A characteristic of the present embodiment is the walking assistance system 10 built in the white cane 1. Hereinafter, the walking assistance system 10 will be described.

First, a basic technical idea of the walking assistance system 10 according to the present embodiment will be described. As described above, in order to improve reliability of avoiding contact of the moving body, such as the bicycle, with the pedestrian, issuing the alert to a driver of the bicycle (occupant of the moving body) to make the driver of the bicycle take contact avoidance behavior (driving the bicycle without coming into contact with the pedestrian) is more effective than issuing the alert to the pedestrian (person who is visually impaired or the like). In particular, in a case where the pedestrian is the person who is visually impaired, it is difficult for the person who is visually impaired to recognize the approach of the bicycle even when the bicycle approaches from the front, and thus issuing the alert to the driver of the bicycle is effective. In addition, in order to make the driver of the bicycle take the contact avoidance behavior, it is a condition that the driver of the bicycle is aware of the presence of the pedestrian. Also, in a case where the driver of the bicycle is already aware of the presence of the pedestrian, the contact avoidance behavior by the driver of the bicycle can be expected, and thus a need for issuing the alert to the driver is low. On the other hand, in a case where the driver of the bicycle is unaware of the presence of the pedestrian, in order to make the driver take the contact avoidance behavior, there is a need for issuing a strong alert for making the driver be aware of the presence of the pedestrian.

The present embodiment has been made in view of this point, and the walking assistance system issues a strong alert for making the driver be aware of the presence of the pedestrian in the case where the driver of the bicycle is unaware of the presence of the pedestrian, and improves the reliability of contact of avoiding the bicycle with the pedestrian by issuing the strong alert.

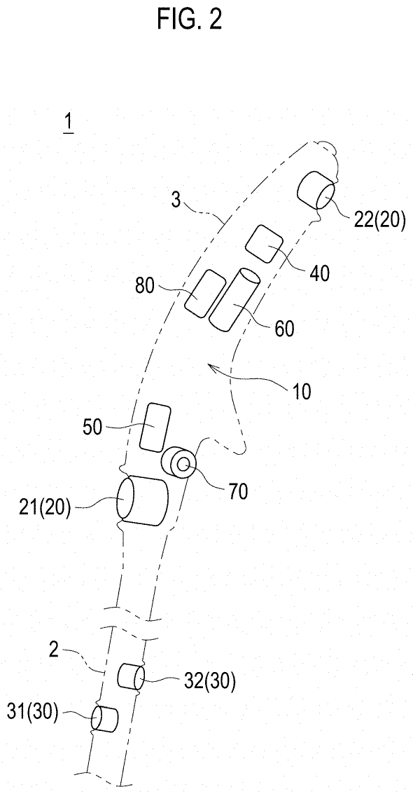

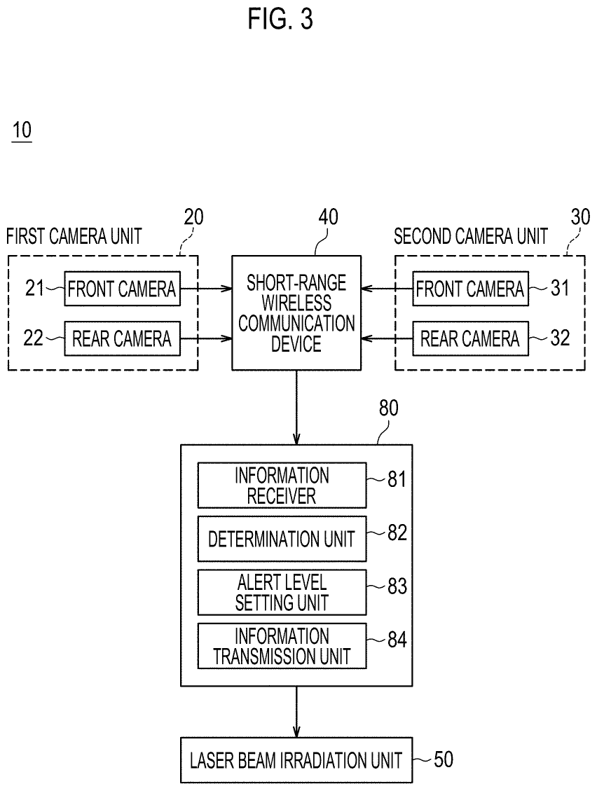

Hereinafter, a specific configuration of the walking assistance system 10 will be described. FIG. 2 is a schematic diagram showing an inside of the grip portion 3 of the white cane 1 and an inside of the shaft portion 2 of the white cane 1. As shown in FIG. 2, the walking assistance system 10 according to the present embodiment is built in the white cane 1. Further, FIG. 3 is a block diagram showing a schematic configuration of a control system of the walking assistance system 10.

As shown in FIGS. 2 and 3, the walking assistance system 10 includes a first camera unit 20, a second camera unit 30, a short-range wireless communication device 40, a laser beam irradiation unit 50, a battery 60, a charging socket 70, a control device 80, and the like.

The first camera unit 20 includes a front camera 21 and a rear camera 22 built in the grip portion 3. The cameras 21, 22 image a periphery of the person who is visually impaired and uses the white cane 1. The front camera 21 is embedded in a front surface of the grip portion 3 (surface facing a traveling direction of the person who is visually impaired) at a base portion of the grip portion 3, and images a front side in the traveling direction of the person who is visually impaired. On the other hand, the rear camera 22 is embedded in a rear surface of the grip portion 3 (surface facing an opposite side to the traveling direction of the person who is visually impaired) at an upper end portion of the grip portion 3, and images a rear side in the traveling direction of the person who is visually impaired. In addition, a field of view of each of the cameras 21, 22 in a horizontal direction is 180° or greater, and an image of 360° (omnidirectional) in the horizontal direction can be acquired by these two cameras 21, 22. Further, the cameras 21, 22 are configured to measure a distance to an object present in the periphery of the person who is visually impaired. For example, the cameras 21, 22 are configured by a stereo camera to measure the distance to the object present in the periphery of the person who is visually impaired.

The second camera unit 30 includes a front camera 31 and a rear camera 32 built in the shaft portion 2. The cameras 31, 32 also image a periphery of the person who is visually impaired and uses the white cane 1. The front camera 31 is embedded in a front surface of the shaft portion 2 (surface facing the traveling direction of the person who is visually impaired), and images the front side in the traveling direction of the person who is visually impaired. On the other hand, the rear camera 32 is embedded in a rear surface of the shaft portion 2 (surface facing the opposite side to the traveling direction of the person who is visually impaired), and images the rear side in the traveling direction of the person who is visually impaired. In addition, a field of view of each of the cameras 31, 32 in a horizontal direction is also 180° or greater, and an image of 360° (omnidirectional) in the horizontal direction can be acquired by these two cameras 31, 32. Further, the cameras 31, 32 are also configured to measure a distance to an object present in the periphery of the person who is visually impaired.

Each of the cameras 21, 22, 31, 32 includes, for example, a charge coupled device (CCD), a complementary metal oxide semiconductor (CMOS), or the like. Each of the cameras 21, 22, 31, 32 may be configured by an infrared camera or the like without being limited to the above. Further, a configuration, an arrangement position, or the number of the camera units 20, 30 is not limited to the above description. For example, a configuration may be adopted in which a power source (electric motor or the like) that rotates one camera around a vertical axis is provided and the image of 360° (omnidirectional) in the horizontal direction can be acquired by the rotation. Also, a configuration may be adopted in which each of the cameras 21, 22, 31, 32 does not have a distance measurement function, a distance sensor (for example, an optical distance sensor or an ultrasound distance sensor) is provided in the white cane 1, and the distance to the object present in the periphery of the person who is visually impaired can be measured.

The short-range wireless communication device 40 is a wireless communication device that performs short-range wireless communication between each of the cameras 21, 22, 31, 32 of the camera units 20, 30 and the control device 80. For example, a configuration is adopted in which the short-range wireless communication is performed between each of the cameras 21, 22, 31, 32 and the control device 80 by a well-known communication means, such as Bluetooth (registered trademark), and information on the image captured by each of the cameras 21, 22, 31, 32 is wirelessly transmitted to the control device 80.

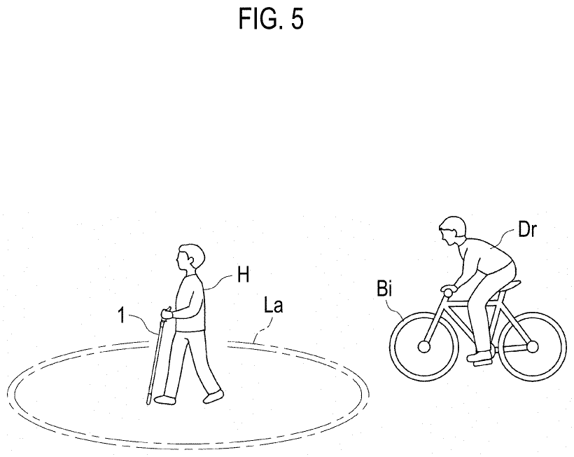

The laser beam irradiation unit 50 is arranged on an upper side of the front camera 21 at the base portion of the grip portion 3. The laser beam irradiation unit 50 includes a plurality of laser beam sources (not shown). A semiconductor laser, an LED, or the like can be applied as the light source (laser beam source). As shown in FIG. 1, the grip portion 3 is provided with a floodlight window 32 over an entire circumferential direction, and the laser beam sources are arranged over an entire periphery of the floodlight window 32. Further, each laser beam source is arranged to emit (radiate) light (laser beam) obliquely downward from the grip portion 3. Therefore, in a case where each laser beam source emits light, the laser beam is emitted obliquely downward from the entire periphery of the grip portion 3, so that an annular irradiation area is generated on a road surface of the periphery of the white cane 1 (periphery of the person who is visually impaired and has the white cane 1) (see FIG. 5). For example, the battery 60 by which the annular irradiation area with a radius of about 1.5 m in the periphery of the person who is visually impaired is generated by appropriately setting a light emission angle of the laser beam from each laser beam source (irradiation angle toward the road surface) is configured by a secondary battery that stores electric power for each of the cameras 21, 22, 31, 32, the short-range wireless communication device 40, the laser beam irradiation unit 50, and the control device 80.

The charging socket 70 is a portion to which a charging cable is connected in a case of storing the electric power in the battery 60. For example, the charging cable is connected in a case where the person who is visually impaired charges the battery 60 from a household power source while at home.

The control device 80 includes, for example, a processor, such as a central processing unit (CPU), a read-only memory (ROM) for storing a control program, a random-access memory (RAM) for transitorily storing data, and an input and output port.

Further, the control device 80 includes an information receiver 81, a determination unit 82, an alert level setting unit 83, and an information transmission unit 84 as functional units thereof.

The information receiver 81 receives the information on the image captured by each of the cameras 21, 22, 31, 32 from each of the cameras 21, 22, 31, 32 via the short-range wireless communication device 40 at predetermined time intervals.

The determination unit 82 receives the information on each image received by the information receiver 81, and determines whether or not the driver of the bicycle is aware of the presence of the pedestrian in a situation where the bicycle approaches the pedestrian based on the information on the image. Specifically, the determination unit 82 specifies the moving object (bicycle in the present embodiment) among the objects present in the periphery of the pedestrian by using artificial intelligence (AI) based on the information on each image received from each of the cameras 21, 22, 31, 32 and calculates a movement direction and movement speed of the bicycle from a position of the bicycle at each predetermined time. Further, the determination is made as to whether or not the bicycle approaches the pedestrian from the movement direction and the movement speed, and in a case where the bicycle approaches the pedestrian, the determination unit 82 determines whether or not the driver of the bicycle is aware of the presence of the pedestrian by recognizing a direction of a face of the driver of the bicycle. For example, based on the information on each image received from each of the cameras 21, 22, 31, 32, the determination unit 82 determines that the driver of the bicycle is aware of the presence of the pedestrian in a case where the recognition is made that the face of the driver of the bicycle faces the position of the pedestrian, and determines that the driver of the bicycle is unaware of the presence of the pedestrian in a case where the recognition is made that the face of the driver of the bicycle does not face the position of the pedestrian.

In a case where the determination unit 82 determines that the driver of the bicycle is unaware of the presence of the pedestrian, the alert level setting unit 83 sets the alert level of the operation by the laser beam irradiation unit 50 that performs an operation for issuing the alert to the driver of the bicycle high as compared with a case where the determination unit 82 determines that the driver of the bicycle is aware of the presence of the pedestrian. Specifically, an instruction signal for increasing an amount of the light emitted by each laser beam source of the laser beam irradiation unit 50 is output to the information transmission unit 84.

The information transmission unit 84 receives an alert level setting signal from the alert level setting unit 83, and transmits the information to the laser beam irradiation unit 50. As a result, each laser beam source of the laser beam irradiation unit 50 emits the light with the amount of the light in response to the received information (alert level setting signal). That is, the amount of the light emitted by each laser beam source is set to be relatively small (small amount of the light) in the case where the determination unit 82 determines that the driver of the bicycle is aware of the presence of the pedestrian. That is, brightness of an annular irradiation area (irradiation area generated in the periphery of a person H who is visually impaired and has the white cane 1) La shown in FIG. 5 is set to be relatively low. On the other hand, the amount of the light emitted by each laser beam source is set to be relatively large (large amount of the light) in the case where the determination unit 82 determines that a driver Dr of a bicycle Bi is unaware of the presence of the pedestrian H. That is, the brightness of the annular irradiation area La shown in FIG. 5 is set to be relatively high.

Walking Assistance Operation

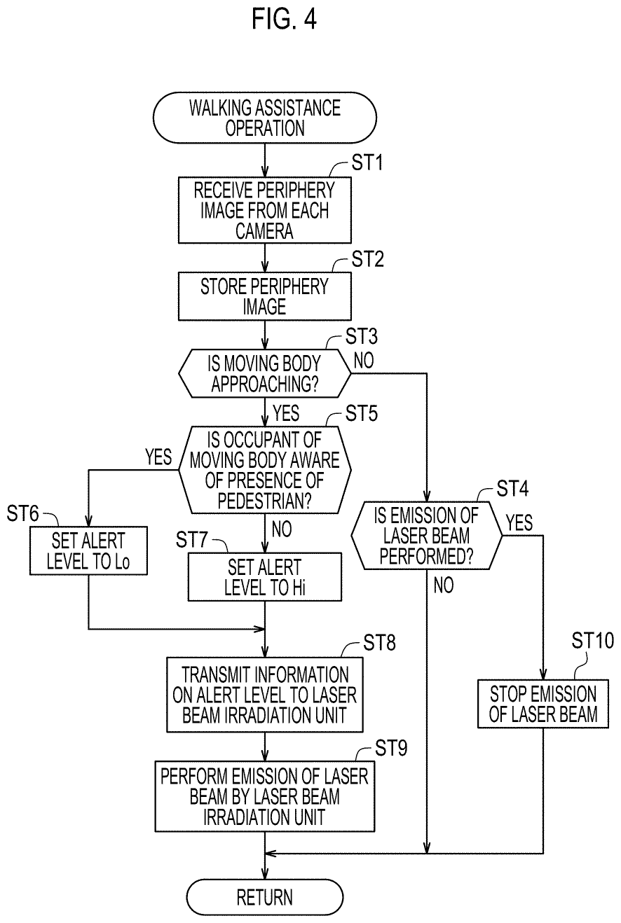

Next, the walking assistance operation by the walking assistance system 10 configured as described above will be described. FIG. 4 is a flowchart showing a procedure of the walking assistance operation. The flowchart is carried out at predetermined time intervals in a situation where the pedestrian (person who is visually impaired) H walks on a road as shown in FIG. 5.

First, in step ST1, the information on a periphery image captured by each of the cameras 21, 22, 31, 32 is transmitted to the control device 80 via the short-range wireless communication device 40 (information receiver 81 receives the information on the periphery image), and then the information is input to the determination unit 82 via the information receiver 81.

In step ST2, the input periphery image is stored. For example, the input periphery image is stored in the RAM provided in the control device 80. The stored information is stored in association with time information.

In step ST3, a determination is made as to whether or not the moving body, such as the bicycle Bi, approaches the pedestrian H. As described above, since the time information is associated with the stored information on the periphery image, the moving object (for example, bicycle Bi) among the objects present in the periphery image can be specified by comparing the periphery images at each time. Then, the movement direction and the movement speed of the bicycle Bi are calculated from the position of the bicycle Bi at each predetermined time interval. In addition, from the movement direction and movement speed, the determination can be made as to whether or not the bicycle Bi approaches the pedestrian H. For example, in the situation where the bicycle Bi approaches the pedestrian H, an occupied area of the bicycle Bi in the image captured by any one of the cameras 22, 32 (21, 31) is rapidly expanded, and thus the determination can be made that the bicycle Bi approaches the pedestrian H by recognizing the expanded occupied area.

In a case where the moving body, such as the bicycle Bi, does not approach the pedestrian H and a NO determination is made in step ST3, the process proceeds to step ST4, and a determination is made whether or not the emission of the laser beam from each laser beam source of the laser beam irradiation unit 50 is being performed. That is, in a previous routine, in a case where the moving body, such as the bicycle Bi, does not approach the pedestrian H and the emission of the laser beam from each laser beam source of the laser beam irradiation unit 50 is not performed, the NO determination is made in step ST4, and the process returns as it is.

On the other hand, in a case where the moving body, such as the bicycle Bi, approaches the pedestrian H and a YES determination is made in step ST3, the process proceeds to step ST5, and a determination is made as to whether or not the occupant of the moving body (driver Dr of the bicycle Bi) is aware of the presence of the pedestrian H. In the determination operation, as described above, based on the information on each image received from each of the cameras 21, 22, 31, 32, the determination unit 82 determines that the driver Dr of the bicycle Bi is aware of the presence of the pedestrian H in a case where the recognition is made that the face of the driver Dr of the bicycle Bi faces the position of the pedestrian H, and determines that the driver Dr of the bicycle Bi is unaware of the presence of the pedestrian H in a case where the recognition is made that the face of the driver Dr of the bicycle Bi does not face the position of the pedestrian H.

In the case where the face of the driver Dr of the bicycle Bi faces the position of the pedestrian H and the determination unit 82 determines that the driver Dr of the bicycle Bi is aware of the presence of the pedestrian H, the YES determination is made in step ST5, the process proceeds to step ST6, and the alert level set by the alert level setting unit 83 is set to Lo. Lo as the setting of the alert level means that an amount of light of the laser beam from each laser beam source of the laser beam irradiation unit 50 is set to be relatively small.

On the other hand, in the case where the face of the driver Dr of the bicycle Bi does not face the position of the pedestrian H and the determination unit 82 determines that the driver Dr of the bicycle Bi is unaware of the presence of the pedestrian H, the NO determination is made in step ST5, the process proceeds to step ST7, and the alert level set by the alert level setting unit 83 is set to Hi. Hi as the setting of the alert level means that the amount of light of the laser beam from each laser beam source of the laser beam irradiation unit 50 is set to be relatively large.

After the alert level is set as described above, the process proceeds to step ST8, and information on the set alert level is transmitted from the information transmission unit 84 to the laser beam irradiation unit 50. Then, in step ST9, each laser beam source of the laser beam irradiation unit 50 emits the light with the amount of the light in response to the received information (alert level setting signal). That is, the amount of the light emitted from each laser beam source is set to be relatively small in the case where the determination unit 82 determines that the driver Dr of the bicycle Bi is aware of the presence of the pedestrian H, whereas the amount of the light emitted by each laser beam source is set to be relatively large in the case where the determination unit 82 determines that a driver Dr of a bicycle Bi is unaware of the presence of the pedestrian H.

Specifically, as shown in FIG. 5, in the case where the bicycle Bi approaches the pedestrian (person who is visually impaired) H, each laser beam source of the laser beam irradiation unit 50 emits the light, so that the annular irradiation area La is generated on the road surface in the periphery of the white cane 1. Further, in the case where the determination unit 82 determines that the driver Dr of the bicycle Bi is unaware of the presence of the pedestrian H, the brightness of the irradiation area La on the road surface (brightness due to the amount of the light from each laser beam source) is bright as compared with the case where the determination unit 82 determines that the driver Dr of the bicycle Bi is aware of the presence of the pedestrian H. As a result, the alert level is set high in the case where the determination unit 82 determines that the driver Dr of the bicycle Bi is unaware of the presence of the pedestrian H, so that a possibility of making the driver Dr of the bicycle Bi be aware of the presence of the pedestrian H (aware that the driver of the bicycle approaches the pedestrian H) is increased. As a result, a possibility that the driver Dr of the bicycle Bi takes the contact avoidance behavior is increased, and the reliability of avoiding contact of the bicycle Bi with the pedestrian H can be improved.

In a situation where each laser beam source of the laser beam irradiation unit 50 emits the light in a situation where the driver Dr of the bicycle Bi is unaware of the presence of the pedestrian H, when the determination unit 82 still determines that the driver Dr of the bicycle Bi is unaware of the presence of the pedestrian H in a next routine, the operations of steps ST1 to ST3, ST5, and ST7 to ST9 are repeated, and a state in which the amount of the light emitted from each laser beam source is set to be relatively large is maintained. Further, in this state, in the case where the determination is made that the driver Dr of the bicycle Bi is aware of the presence of the pedestrian H (case where the driver Dr of bicycle Bi who has been unaware of the presence of the pedestrian H so far is aware of the presence of the pedestrian H), the YES determination is made in step ST5, in this case, the operations are switched to the operations of steps ST1 to ST3, ST5, ST6, ST8, and ST9, and thus the amount of the light emitted from each laser beam source is set to be relatively small.

Further, in the situation where each laser beam source of the laser beam irradiation unit 50 emits the light as described above, in a case where the bicycle Bi passes the periphery of the pedestrian H, the situation where the bicycle Bi approaches the pedestrian H is released, the NO determination is made in step ST3, and the process proceeds to step ST4. Then, in this case, since each laser beam source of the laser beam irradiation unit 50 emits the light, the YES determination is made in step ST4, and the process proceeds to step ST10. In step ST10, the light emission from each laser beam source of the laser beam irradiation unit 50 is stopped, and the annular irradiation area La generated on the road surface is also released.

The operations described above are repeated.

Effect of Embodiment

As described above, in the present embodiment, the alert level setting unit 83 sets the alert level of the operation for issuing the alert high in the case where the determination unit 82 determines that the driver Dr of the bicycle Bi is unaware of the presence of the pedestrian H, as compared with the case where the determination unit 82 determines that the driver Dr of the bicycle Bi is aware of the presence of the pedestrian H. Specifically, the amount of light of the laser beam from each laser beam source of the laser beam irradiation unit 50 is set to be relatively large. As described above, the alert level is set high in the case where the determination unit 82 determines that the driver Dr of the bicycle Bi is unaware of the presence of the pedestrian H, so that the possibility of making the driver Dr of the bicycle Bi be aware of the presence of the pedestrian H is increased. As a result, a possibility that the driver Dr of the bicycle Bi takes the contact avoidance behavior is increased, and the reliability of avoiding contact of the bicycle Bi with the pedestrian H can be improved.

Further, in the present embodiment, the first camera unit 20 and the second camera unit 30 are used in combination to image the periphery of the person H who is visually impaired. Since the person H who is visually impaired grips the white cane 1 and walks while swinging the white cane 1 to right and left, there is a possibility that lenses of the cameras 21, 22 are covered with a hand or the captured image is distorted, but the reliability of acquiring the periphery image can be improved by providing two camera units 20, 30. In addition, these camera units 20, 30 can continuously image the moving body, such as the bicycle Bi, and calculate the movement speed at high precision. In particular, in the present embodiment, since the moving body (bicycle Bi) that approaches the pedestrian H is detected by the images captured by a plurality of the cameras 21, 22, 31, 32 and the AI, a high detection precision of the speed of the moving body can be obtained and an adverse effect of the disturbance can be almost eliminated.

Modification Examples of Emission Mode of Laser Beam

In the embodiment described above, the annular irradiation area La is generated on the road surface as an emission mode of the laser beam for issuing the alert to the driver Dr of the bicycle Bi. Other emission modes of laser beam include the following without being limited to the above.

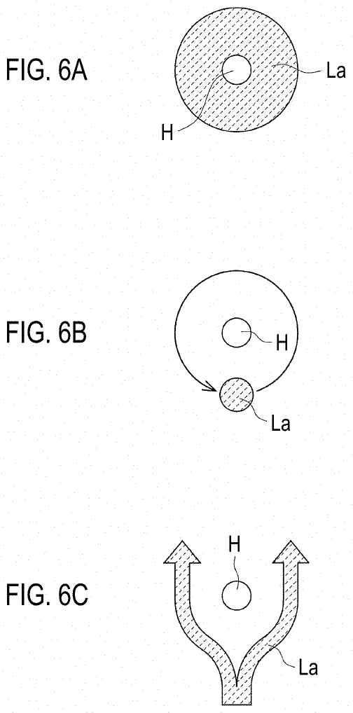

FIG. 6A shows an emission mode in which the light is emitted to the entire inside of the circular irradiation area La generated on the road surface. In FIG. 6A, the light is emitted to an area shaded by broken lines. Further, H in FIG. 6A is the position of the pedestrian. Also in this case, the amount of the light is set to be relatively small in the case where the determination unit 82 determines that the driver Dr of the bicycle Bi is aware of the presence of the pedestrian H, whereas the amount of the light is set to be relatively large in the case where the determination unit 82 determines that a driver Dr of a bicycle Bi is unaware of the presence of the pedestrian H.

FIG. 6B shows an emission mode in which small-diameter light (spotlight) La is scanned along a circular scanning locus surrounding the pedestrian H. An arrow in FIG. 6B indicates a scanning direction of the small-diameter light La. Also in this case, the amount of the light is set to be relatively small in the case where the determination unit 82 determines that the driver Dr of the bicycle Bi is aware of the presence of the pedestrian H, whereas the amount of the light is set to be relatively large in the case where the determination unit 82 determines that a driver Dr of a bicycle Bi is unaware of the presence of the pedestrian H.

FIG. 6C shows an emission mode in which an arrow as a traveling route for avoiding the pedestrian H is shown as the light emitted to the road surface. Also in this case, the amount of the light is set to be relatively small in the case where the determination unit 82 determines that the driver Dr of the bicycle Bi is aware of the presence of the pedestrian H, whereas the amount of the light is set to be relatively large in the case where the determination unit 82 determines that a driver Dr of a bicycle Bi is unaware of the presence of the pedestrian H.

The mode of the light emitted to the road surface is not limited to the above, and can be optionally set.

Modification Example of Light in which Alert Level is Set High

In the embodiment described above, the amount of the light emitted by each laser beam source is set to be relatively large as an operation for raising the alert level. Instead of or in addition to the above, the alert level may be raised by setting the light emitted from each laser beam source as follows.

First, as an example, there is an operation for blinking the light emitted from each laser beam source as an operation with a high alert level in contrast with an operation for not blinking the light as an operation with a low alert level. That is, in a case of the embodiment described above and in each case shown in FIGS. 6A to 6C, the alert level is raised by blinking the light to increase a possibility of making the driver Dr of the bicycle Bi be aware of the presence of the pedestrian H.

Further, as an example of the operation with the high alert level, there is also an operation for increasing blinking speed of the light as compared with the operation with the low alert level, in a case where the light is blinked as the operation for issuing the alert. By increasing the blinking speed of the light, the possibility of making the driver Dr of the bicycle Bi be aware of the presence of the pedestrian H can be increased.

In addition, as an example, in a case where the light is scanned in the periphery of the position of the pedestrian H as the operation for issuing the alert, there is also an operation for increasing scanning speed of the light, as the operation with the high alert level, as compared with the operation with the low alert level. For example, as shown in FIG. 6B, in a case where the small-diameter light La is scanned, the possibility of making the driver Dr of the bicycle Bi be aware of the presence of the pedestrian H can be increased by increasing the scanning speed.

In addition, as an example, there is also an operation for emitting light of a color having a long wavelength, as the operation with the high alert level, as compared with the operation with the low alert level. For example, there is an operation for emitting red light to the road surface as the operation with the high alert level in contrast with an operation for emitting yellow light to the road surface as the operation with the low alert level. Since the light having the long wavelength has high visibility, the possibility of making the driver Dr of the bicycle Bi be aware of the presence of the pedestrian H can be increased by emitting the light of the color having the long wavelength.

It should be noted that even in the operations for changing the blinking state, the scanning speed, and the wavelength of light described above, these operations may be combined with each other.

Modification Example Other than Laser Beam

In the embodiment described above, as the operation for raising the alert level, the light emitted from each laser beam source is used. Instead of or in addition to the above, the alert level may be raised by operations as follows.

First, the white cane 1 is provided with a speaker, and in the case where the bicycle Bi approaches the pedestrian H, a warning sound is issued to the driver Dr of the bicycle Bi. In this case, examples of the operation for raising the alert level of the operation for issuing the alert include the operation for increasing the volume of the warning sound as compared with the operation with the low alert level, and the operation for increasing the frequency of the warning sound as compared with the operation with the low alert level. Further, these operations may be combined with each other or combined with the operation for changing the light emission state described above. It should be noted that the operation for raising the alert level in a case where the warning sound is issued is not limited to the above.

Modification Example in which Device or Facility Other than White Cane is Used

In the embodiment described above, all the components constituting the walking assistance system 10 are built in the white cane 1. That is, the cameras 21, 22, 31, 32 as the unit (moving body detection unit) that detects the bicycle (moving body) Bi that approaches the person H who is visually impaired (pedestrian), the control device 80 including the determination unit 82 that determines whether or not the driver Dr of the bicycle Bi is aware of the presence of the person H who is visually impaired and the alert level setting unit 83 that sets the alert level high in the case where the determination unit 82 determines that the driver Dr of the bicycle Bi is unaware of the presence of the person H who is visually impaired, and the laser beam irradiation unit 50 (alert unit) that performs the operation for issuing the alert to the driver Dr of the bicycle Bi are built in the white cane 1.

The walking assistance system 10 is not limited to the above, and may be constructed by a plurality of devices or facilities. For example, the walking assistance system 10 may be constructed by using the portable terminal (smartphone) carried by the driver Dr of the bicycle Bi, or the facility installed on the road, such as the street light, the traffic light, or the utility pole.

For example, the walking assistance system 10 may be constructed such that each of the moving body detection unit, the alert unit, and the control device 80 is built in the portable terminal carried by the driver Dr of the bicycle Bi. In this case, the camera of the portable terminal corresponds to the moving body detection unit. Further, as the operation for determining whether or not the driver Dr of the bicycle Bi is aware of the presence of the pedestrian H by the portable terminal, the direction of the face of the driver Dr of the bicycle Bi may be recognized by the camera of the portable terminal, or the determination may be made that the driver Dr of the bicycle Bi is unaware of the presence of the pedestrian H in a case where the portable terminal is operated. Further, for example, a vibration device (vibrator) built in the portable terminal corresponds to the alert unit, and as the operation for issuing the alert to the driver Dr of the bicycle Bi, the vibration device is vibrated. Further, examples of the operation for raising the alert level of the operation for issuing the alert include an operation for increasing amplitude of the vibration as compared with the operation with the low alert level, and an operation for reducing an interval of the vibration in a case where the vibration is intermittently caused as compared with the operation with the low alert level. Also, these operations may be combined. It should be noted that the operation for raising the alert level in a case where the portable terminal is vibrated is not limited to the above.

In addition, the speaker of the portable terminal may be used as the alert unit. That is, the warning sound is issued from the speaker as the operation for issuing the alert to the driver Dr of the bicycle Bi. Further, examples of the operation for raising the alert level of the operation for issuing the alert include the operation for increasing the volume of the warning sound as compared with the operation with the low alert level, and the operation for increasing the frequency of the warning sound as compared with the operation with the low alert level. Also, these operations may be combined. It should be noted that the operation for raising the alert level in a case where the warning sound is issued from the portable terminal is not limited to the above.

In addition, a smell generation device of the portable terminal may be mounted on the portable terminal as the alert unit. That is, as the operation for issuing the alert to the driver Dr of the bicycle Bi, the smell is generated from the smell generation device. Then, examples of the operation for raising the alert level of the operation for issuing the alert include an operation for increasing intensity of the smell as compared with the operation with the low alert level.

Further, the walking assistance system 10 may be constructed such that each of the moving body detection unit, the alert unit, and the control device 80 is mounted on the facility (street light, traffic light, utility pole, or the like). In this case, the camera mounted on the facility corresponds to the moving body detection unit. Further, as the alert unit, the speaker is mounted on the facility, and the warning sound is issued to the driver Dr of the bicycle Bi. Further, examples of the operation for raising the alert level of the operation for issuing the alert include the operation for increasing the volume of the warning sound as compared with the operation with the low alert level, and the operation for increasing the frequency of the warning sound as compared with the operation with the low alert level. Also, these operations may be combined. It should be noted that the operation for raising the alert level in a case where the warning sound is issued from the speaker mounted on the facility is not limited to the above.

Modification Example Combining Plurality of Devices or Facilities

Further, the walking assistance system 10 may be constructed by combining a plurality of devices or facilities. That is, a functional unit of the walking assistance system 10 may be arranged in each of the white cane 1, the portable terminal carried by the driver Dr of the bicycle Bi, and the facility installed on the road to construct the walking assistance system 10 by the devices or the facilities. Hereinafter, a representative example in this case will be described.

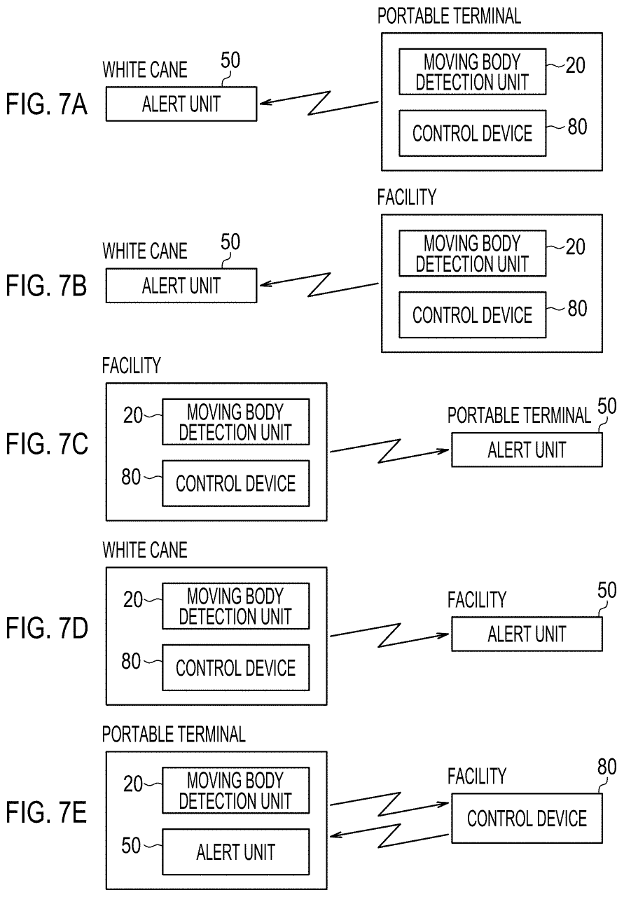

FIGS. 7A to 7E are block diagrams showing schematic configurations of modification examples in which the walking assistance system 10 is constructed by two devices or facilities.

FIG. 7A shows an example in which the walking assistance system 10 is constructed by combining the white cane 1 and the portable terminal carried by the driver Dr of the bicycle Bi. For example, a configuration is adopted in which the alert unit (laser beam irradiation unit or the like described above; with reference numeral 50 in FIGS. 7A to 7E) is built in the white cane 1 and the moving body detection unit (camera of the portable terminal or the like; with reference numeral 20 in FIGS. 7A to 7E) and the control device 80 are built in the portable terminal carried by the driver Dr of the bicycle Bi. In this case, the detection is made that the bicycle (bicycle driven by the driver Dr him/herself) Bi approaches the pedestrian H by the portable terminal carried by the driver Dr of the bicycle Bi, the alert level is set by the control device 80, the information on the set alert level is transmitted to the white cane 1, and the alert unit 50 of the white cane 1 is activated in response to the set alert level (for example, the laser beam is emitted to the road surface from the laser beam irradiation unit 50).

FIG. 7B shows an example in which the walking assistance system 10 is constructed by combining the white cane 1 and the facility. For example, a configuration is adopted in which the alert unit (laser beam irradiation unit or the like described above) 50 is built in the white cane 1 and the moving body detection unit (camera or the like) 20 and the control device 80 are mounted on the facility. In this case, the detection is made that the bicycle Bi approaches the pedestrian H by the moving body detection unit 20 in the facility, the alert level is set by the control device 80, the information on the set alert level is transmitted to the white cane 1, and the alert unit 50 of the white cane 1 is activated in response to the set alert level (for example, the laser beam is emitted to the road surface from the laser beam irradiation unit 50).

FIG. 7C shows another example in which the walking assistance system 10 is constructed by combining the white cane 1 and the portable terminal carried by the driver Dr of the bicycle Bi. For example, a configuration is adopted in which the moving body detection unit (camera or the like) 20 and the control device 80 are built in the white cane 1 and the alert unit (vibration device, speaker, or the like described above) 50 is built in the portable terminal carried by the driver Dr of the bicycle Bi. In this case, the detection is made that the bicycle Bi approaches the pedestrian H by the moving body detection unit 20 of the white cane 1, the alert level is set by the control device 80, the information on the set alert level is transmitted to the portable terminal carried by the driver Dr of the bicycle Bi, and the alert unit 50 of the portable terminal is activated in response to the set alert level (for example, the vibration is caused by the vibration device or the warning sound is issued from the speaker).

FIG. 7D shows another example in which the walking assistance system 10 is constructed by combining the white cane 1 and the facility. For example, a configuration is adopted in which the moving body detection unit (camera or the like) 20 and the control device 80 are built in the white cane 1 and the alert unit (speaker or the like described above) 50 is mounted on the facility. In this case, the detection is made that the bicycle Bi approaches the pedestrian H by the moving body detection unit 20 of the white cane 1, the alert level is set by the control device 80, the information on the set alert level is transmitted to the facility, and the alert unit 50 in the facility is activated in response to the set alert level (for example, the warning sound is issued from the speaker).

FIG. 7E shows an example in which the walking assistance system 10 is constructed by combining the portable terminal carried by the driver Dr of the bicycle Bi and the facility. For example, a configuration is adopted in which the moving body detection unit (camera of the portable terminal or the like) 20 and the alert unit (vibration device, speaker, or the like described above) 50 are built in the portable terminal carried by the driver Dr of the bicycle Bi and the control device 80 is mounted on the facility. In this case, the detection is made that the bicycle (bicycle driven by the driver Dr him/herself) Bi approaches the pedestrian H by the portable terminal carried by the driver Dr of the bicycle Bi, and the information is transmitted to the facility. Further, the alert level is set by the control device 80 in the facility, the information on the set alert level is transmitted to the portable terminal carried by the driver Dr of the bicycle Bi, and the alert unit 50 of the portable terminal is activated in response to the set alert level (for example, the vibration is caused by the vibration device or the warning sound is issued from the speaker).

The example in which the walking assistance system 10 is constructed by the two devices or facilities is not limited to the above, and the walking assistance system 10 can be constructed by any combination.

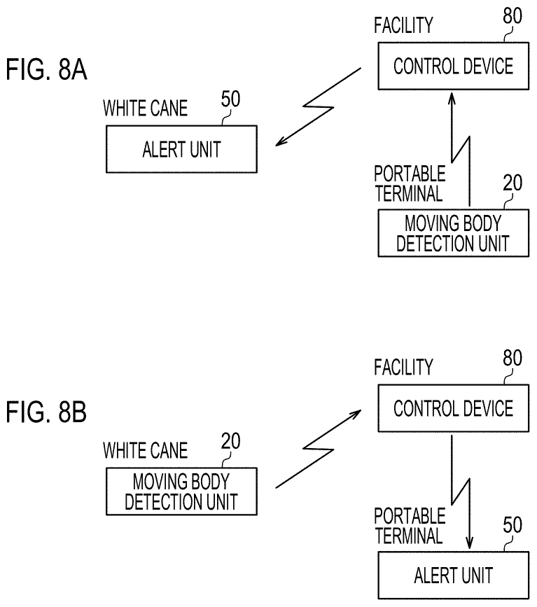

FIGS. 8A and 8B are block diagrams showing schematic configurations of modification examples in which the walking assistance system 10 is constructed by three devices or facilities.

In FIG. 8A, a configuration is adopted in which the alert unit (laser beam irradiation unit or the like described above) 50 is built in the white cane 1, the moving body detection unit (camera of the portable terminal or the like) 20 is built in the portable terminal carried by the driver Dr of the bicycle Bi, and the control device 80 is mounted on the facility. In this case, the detection is made that the bicycle (bicycle driven by the driver Dr him/herself) Bi approaches the pedestrian H by the portable terminal carried by the driver Dr of the bicycle Bi, and the information is transmitted to the control device 80 in the facility. Then, the alert level is set by the control device 80, the information on the set alert level is transmitted to the white cane 1, and the alert unit 50 of the white cane 1 is activated in response to the set alert level (for example, the laser beam is emitted to the road surface from the laser beam irradiation unit 50).

In FIG. 8B, a configuration is adopted in which the moving body detection unit (camera or the like) 20 is built in the white cane 1, the control device 80 is mounted on the facility, and the alert unit (vibration device, speaker, or the like described above) 50 is built in the portable terminal carried by the driver Dr of the bicycle Bi. In this case, the detection is made that the bicycle Bi approaches the pedestrian H by the moving body detection unit 20 of the white cane 1, and the information is transmitted to the control device 80 of the facility. Further, the alert level is set by the control device 80, the information on the set alert level is transmitted to the portable terminal carried by the driver Dr of the bicycle Bi, and the alert unit 50 of the portable terminal is activated in response to the set alert level (for example, the vibration is caused by the vibration device or the warning sound is issued from the speaker).

The example in which the walking assistance system 10 is constructed by the three devices or facilities is also not limited to the above, and the walking assistance system 10 can be constructed by any combination.

### Other Embodiments

It should be noted that the present disclosure is not limited to the embodiment described above and each of the modification examples described above, and all modifications and applications included in the claims and the range equivalent to the claims can be made.

For example, in the embodiment described above and each of the modification examples, the alert is issued to the driver Dr of the bicycle Bi, but in addition to this, the alert may be issued to the pedestrian H. For example, the white cane 1 is provided with the vibration device, and in the case where the bicycle Bi approaches the pedestrian H, the vibration device generates the vibration.

Further, in the embodiment described above and each of the modification examples, the white cane 1 is provided with the charging socket 70, and the battery (secondary battery) 60 is charged from the household power source. The present disclosure is not limited to this, and a photovoltaic power generation sheet may be attached to a surface of the white cane 1 and the battery 60 may be charged by the electric power generated by the photovoltaic power generation sheet. Also, a primary battery may be used instead of the secondary battery. Further, a pendulum generator may be built in the white cane 1, and the pendulum generator may be used to charge the battery 60.

In addition, in the embodiment described above and each of the modification examples, the walking assistance system 10 used on a general road (public road) is assumed. The present disclosure is not limited to this, and can be applied as the walking assistance system 10 used on a private road or indoors.

Further, in the embodiment described above and each of the modification examples, the case where one bicycle Bi approaches the pedestrian H is described as an example, but the setting operation for the alert level described above may be performed with respect to each bicycle Bi even in a case where a plurality of the bicycles Bi approaches the pedestrian H.

Further, in the embodiment described above and each of the modification examples, in the situation where the bicycle Bi approaches the pedestrian H, in both the case where the driver Dr of the bicycle Bi is aware of the presence of the pedestrian H and the case where the driver Dr of the bicycle Bi is unaware of the presence of the pedestrian H, the operation for issuing the alert (light emission of the laser beam from each laser beam source) is performed. As described above, in the case where the driver Dr of the bicycle Bi is aware of the presence of the pedestrian H, the contact avoidance behavior by the driver Dr can be expected, and thus in this case, the operation for issuing the alert may not be performed.

Further, in the embodiment described above and each of the modification examples, the driver Dr of the bicycle Bi is described as an example of the occupant of the moving body, but the present disclosure is not limited to this, the concept of the occupant of the moving body includes a driver of a vehicle, a driver of a train, and the like. Further, the concept of the moving body that approaches the pedestrian H includes a human, an animal, and the like.

Further, in the embodiment described above and each of the modification examples, the white cane 1 is used as an example of the use article of the pedestrian H, but the present disclosure is not limited to this, and the use article may be a cane, a rollator, or the like in a case where the pedestrian is an aged person. Further, examples of the carrying article of the pedestrian H in a case where the walking assistance system 10 is constructed by using the carrying article of the pedestrian H include a portable terminal and a bag. Further, the carrying article that emits the light to the road surface may be a portable lighting device or the like. Further, examples of the wearing article of the pedestrian H in a case where the walking assistance system 10 is constructed by using the wearing article of the pedestrian H include eyeglasses, a belt, a hat, and shoes. Further, examples of the carrying article of the moving body in a case where the walking assistance system 10 is constructed by using the carrying article of the moving body (moving body approaches the pedestrian H) include a portable terminal and a bag in the case where the moving body is a human. Further, examples of the wearing article of the moving body in a case where the walking assistance system 10 is constructed by using the wearing article of the moving body include eyeglasses, a belt, a hat, and shoes in the case where the moving body is a human. Further, the carrying article of the occupant of the moving body in a case where the walking assistance system 10 is constructed by using the carrying article of the occupant of the moving body (driver Dr of the bicycle Bi) is not limited to the portable terminal described above, and examples thereof include a bag. Further, examples of the wearing article of the occupant of the moving body in a case where the walking assistance system 10 is constructed by using the wearing article of the occupant of moving body include eyeglasses, a belt, a hat, and shoes.

Further, in a case where the pedestrian H walks across the pedestrian crossing, the alert (warning) operation different from that of other cases may be performed. For example, in the situation where the bicycle Bi approaches in the case where the pedestrian H walks across the pedestrian crossing, the alert level may be set further high, or the alert may be issued to the pedestrian H by the vibration by the vibration device provided in the white cane 1 or the like. Also, in the case where the pedestrian H walks across the pedestrian crossing, even when the traffic light is switched from blue to red, the alert level may be set further high, or the alert may be issued to the pedestrian H by the vibration by the vibration device provided in the white cane 1 or the like.

The present disclosure can be applied to the walking assistance system for avoiding contact of the bicycle with the person who is visually impaired in the case where the bicycle approaches the walking person who is visually impaired.

1. A walking assistance system that performs an operation for avoiding contact of a moving body with a pedestrian in a case where the moving body approaches the pedestrian, the walking assistance system comprising:
a determination unit configured to receive information from a moving body detection unit that has detected the moving body in a situation where the moving body approaches the pedestrian and to determine whether or not the moving body or an occupant of the moving body is aware of a presence of the pedestrian; and
an alert level setting unit configured to output information in which an alert level of an operation for issuing an alert to the moving body or the occupant of the moving body is set high, the operation being performed by an alert unit, in a case where the determination unit determines that the moving body or the occupant of the moving body is unaware of the presence of the pedestrian, as compared with a case where the determination unit determines that the moving body or the occupant of the moving body is aware of the presence of the pedestrian.

2. A walking assistance system that performs an operation for avoiding contact of a moving body with a pedestrian in a case where the moving body approaches the pedestrian, the walking assistance system comprising:
a moving body detection unit configured to detect the moving body that approaches the pedestrian;
an alert unit configured to perform an operation for issuing an alert to the moving body or an occupant of the moving body;
a determination unit configured to receive information from the moving body detection unit and determine whether or not the moving body or the occupant of the moving body is aware of a presence of the pedestrian; and
an alert level setting unit configured to output information in which an alert level of the operation for issuing the alert by the alert unit is set high, in a case where the determination unit determines that the moving body or the occupant of the moving body is unaware of the presence of the pedestrian, as compared with a case where the determination unit determines that the moving body or the occupant of the moving body is aware of the presence of the pedestrian.

3. The walking assistance system according to claim 1, wherein:
the moving body detection unit is a camera configured to image a periphery of the pedestrian; and
the determination unit is configured to determine whether or not the moving body or the occupant of the moving body is aware of the presence of the pedestrian by recognizing a movement state of the moving body or a state of the occupant of the moving body, based on information on an image transmitted from the camera.

4. The walking assistance system according to claim 1, wherein:
the moving body is a bicycle;
the determination unit is configured to determine whether or not a driver who is the occupant of the bicycle is aware of the presence of the pedestrian; and
the alert unit is configured to perform the operation for issuing the alert to the driver of the bicycle.

5. The walking assistance system according to claim 1, wherein:
the alert unit is configured to emit light to a road surface in a periphery of a position of the pedestrian, as the operation for issuing the alert to the moving body or the occupant of the moving body; and
an operation for raising the alert level of the operation for issuing the alert is at least one of
an operation for increasing an amount of the light as compared with an operation with a low alert level,
an operation for blinking the light in contrast with an operation for not blinking the light as the operation with the low alert level,
an operation for increasing blinking speed of the light in a case where the light is blinked as the operation for issuing the alert, as compared with the operation with the low alert level,
an operation for increasing scanning speed of the light in a case where the light is scanned in the periphery of the position of the pedestrian as the operation for issuing the alert, as compared with the operation with the low alert level, and
an operation for emitting light of a color with a long wavelength as compared with the operation with the low alert level.

6. The walking assistance system according to claim 1, wherein:
the alert unit is configured to issue a warning sound to the moving body or the occupant of the moving body as the operation for issuing the alert to the moving body or the occupant of the moving body; and
an operation for raising the alert level of the operation for issuing the alert is at least one of an operation for increasing volume of the warning sound as compared with an operation with a low alert level, and
an operation for increasing a frequency of the warning sound as compared with the operation with the low alert level.

7. The walking assistance system according to claim 1, wherein:
the alert unit is configured to cause a vibration of a terminal carried by the moving body or the occupant of the moving body as the operation for issuing the alert to the moving body or the occupant of the moving body; and
an operation for raising the alert level of the operation for issuing the alert is at least one of
an operation for increasing amplitude of the vibration as compared with an operation with a low alert level, and
an operation for reducing an interval of the vibration in a case where the vibration is intermittently caused as the operation for issuing the alert, as compared with the operation with the low alert level.

8. The walking assistance system according to claim 1, wherein:
the alert unit is configured to issue a warning sound from a terminal carried by the moving body or the occupant of the moving body as the operation for issuing the alert to the moving body or the occupant of the moving body; and
an operation for raising the alert level of the operation for issuing the alert is at least one of an operation for increasing volume of the warning sound as compared with an operation with a low alert level, and
an operation for increasing a frequency of the warning sound as compared with the operation with the low alert level.

9. The walking assistance system according to claim 1, wherein:
the alert unit is configured to generate a smell from a terminal carried by the moving body or the occupant of the moving body as the operation for issuing the alert to the moving body or the occupant of the moving body; and
an operation for raising the alert level of the operation for issuing the alert is an operation for increasing intensity of the smell as compared with an operation with a low alert level.

10. The walking assistance system according to claim 1, wherein each of the moving body detection unit, the alert unit, the determination unit, and the alert level setting unit is provided in one of a use article, a carrying article, or a wearing article of the pedestrian, a carrying article or a wearing article of the moving body, a carrying article or a wearing article of the occupant of the moving body, and a facility installed on a road.

11. The walking assistance system according to claim 10, wherein:
the use article of the pedestrian is a white cane used by a person who is visually impaired; and
the moving body detection unit, the alert unit, the determination unit, and the alert level setting unit are built in the white cane.
